(19) United States
(12) Patent Application Publication
(10) Pub. No.: US 2014/0339150 A1
(43) Pub. Date: Nov. 20, 2014

(54) Filter With Captured Membrane

(71) Applicant: World Wide Water Solutions, Gilbert, AZ (US)

(72) Inventor: Dennis Chancellor, Gilbert, AZ (US)

(73) Assignee: World Wide Water Solutions, Gilbert, AZ (US)

(21) Appl. No.: 13/896,056

(22) Filed: May 16, 2013

(51) Int. Cl. B01D 63/10

(52) U.S. Cl. CPC B01D 63/10
USPC 210/321.85; 210/435; 210/321.6

(57) ABSTRACT

The present inventive concept relates to devices and methods for pressure filtration utilizing spiral wound membranes, in which the volume between the filter membrane and the filter housing is partially or essentially completely filled with an impermeable material. The resulting device permits rapid filtration rates with improved pressure resistance and reduced contamination and microbial growth within the filtration device.

### FIELD OF THE INVENTION

The field of the invention is pressurized ultrafiltration and, more particularly, ultrafiltration modules for use in various reverse osmosis applications, and a method of constructing same.

### BACKGROUND

Ultrafiltration is a separation technology in which a pressure gradient is generated across a semipermeable membrane. Suspended solids, high molecular weight molecules, salts, and other components of the feed stream applied to the ultrafiltration device that cannot pass through the semipermeable membrane are retained in the feed stream, whereas components of the feed stream that can pass through the semipermeable membrane are collected as a permeate. Useful products from the process can be the permeate, the concentrated feed stream, or both.

The selectivity of the semipermeable membrane is due, at least in part, to the dimensions of pores or channels that transect the membrane's thickness. Semipermeable membranes are available in a variety of materials and pore sizes, which has led to the application of ultrafiltration in a wide variety of processes, including therapeutic dialysis, clarification of beverages, concentration of suspensions by removal of solvent, removal of pathogens from pharmaceuticals, and wastewater treatment. A particularly notable application of ultrafiltration is reverse osmosis, in which a semipermeable membrane is selected that excludes salts and other dissolved solids, only allowing the passage of water into the permeate. This is utilized extensively in the preparation of highly purified water for research, pharmaceutical, and food purposes, and in desalination processes.

The filtration rate in ultrafiltration is determined by several factors, including the surface area of semipermeable membrane that is exposed to the feed stream and the pressure that is applied. Since production of large semipermeable membranes can entail considerable expense, a common configuration for such devices is to place the semipermeable membrane, or a filtration module containing such a semipermeable membrane, inside of a pressure resistant housing that allows the use of elevated pressures. In some devices the filter module is inserted into an open end of such a housing, which is then sealed with a cap or fitting that includes an O ring or similar device. Unfortunately failure of such seals can occur at high pressures, leading to failure of the ultrafiltration device. Similarly, the use of such elevated pressures can lead to distortion or “telescoping” of the ultrafiltration membranes, which can damage the membrane and related fluid connections. In addition, excluded materials from the feed stream can accumulate within the housing, encouraging undesirable bacterial growth.

Semipermeable membranes are either as hollow fibers with semipermeable walls or as semipermeable membrane sheets. In ultrafiltration devices that utilize hollow fiber membranes, the feed stream can be applied to the exterior surface of a bundle of hollow fibers, flowing around and through the bundle. In such an arrangement the permeate passes through to the interior of the hollow fibers and is collected. Alternatively, a fluid feed stream can be applied to the interior of the hollow fibers and the permeate collected from the space surrounding the bundle. As a result of their geometry such hollow fiber ultrafiltration membranes are somewhat pressure resistant, but have limited surface area. Filtration rates through hollow fiber ultrafiltration devices can, therefore, be relatively slow. For example, U.S. Pat. No. 5,059,374 (filed Dec. 14, 1989, to Krueger et al) and European Patent Application Number EP1442782A1 (filed Oct. 31, 2002, to Taniguchi and Ishibashi) describe hollow fiber filter assemblies in which the hollow fiber membranes are imbedded in a band of potting material at the end of the filter housing, providing a seal and compartmentalizing the housing. Unfortunately, these do not address the issue of semipermeable membrane distortion under pressure. International Patent Application Number WO2013/039771A1 (filed Sep. 12, 2012, to Taylor and Bouldin) describes an approach to address this issue, in which the bundle of hollow fibers is partially surrounded by tape, shims, rings, or similar devices that direct the stress produced by such distortions to the wall of the filter housing. In addition, hollow fiber ultrafiltration devices require the inclusion of space around the individual fibers, which in turn permits accumulation of materials from the concentrated feed stream and encourages bacterial growth.

The use of semipermeable membrane sheets allows for far greater filter area, permitting higher filtration rates. In ultrafiltration devices that utilize semipermeable membrane sheets, the sheets are often layered with spacer materials that permit fluid flow and wound in a spiral fashion around a central core. The spacer materials form fluid channels that allow the feed stream to flow along the wound membrane, while the central core can serve to collect the permeate. The feed stream is directed through an end of the spirally wound semipermeable membrane using a distribution plate, which directs the feed stream flow through the channels provided by the spacer material. Bypass flow from such distribution plates can lead to the introduction of feed stream fluid into the space, or gap volume, between the spiral wound membrane and the housing, with resulting contamination and bacterial growth.

International Patent Application WO2013/033616A1 (Filed Aug. 31, 2012, to Lesan and Kordani) describes the use of vented sealing devices at the ends of the spiral wound membrane that reduce, but do not eliminate, this bypass flow. U.S. Pat. No. 5,192,437 (filed Aug. 20, 1990, to Chang and Blanck) describes various means for reducing the gap volume around the spiral wound membrane and addressing the problem of membrane distortion, including wrapping the spiral wound membrane with tape and occupying the remaining space in the housing with a gasket or with epoxy, and wrapping the spiral wound membrane in netting while providing a plug of epoxy material at one end of the wound membrane to bond it to the housing wall. Similarly, United States Patent Application Number 2005/0067340 (filed Nov. 15, 2002, to Broens et al) discloses occupying the space between the spiral wound membrane and the housing with a granular filler, for example activated carbon, which can also serve to treat the feed stream fluid. In a related approach, U.S. Pat. No. 5,034,126 (filed Jun. 7, 1990, to Reddy, Moon, and Reineke) describes the use of one or more barriers that extend from the surface of the spiral wound membrane to the wall of the pressure housing in order to divide this space into distinct compartments. However, all of these approaches leave a residual gap volume around the filter membrane, which can accumulate stagnant fluid and thereby act as a reservoir for breeding bacteria and fungus. The gap can also allow undesirable membrane distortion under high operating pressures.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

Thus, there is still a need for a simple and reliable ultrafiltration device that supports high operating pressures while reducing membrane distortion and reducing or eliminating the accumulation of contamination within the device.

### SUMMARY OF THE INVENTION

The inventive subject matter provides apparatus, systems and methods that use a filler to at least partially fill a gap between the filter assembly and pressure housing.

In one embodiment of the inventive concept, a gap volume is defined at least in part by (a) an inner wall of the housing and (b) an outer wall of a filter module that lies within the housing. In some embodiments of the inventive concept the filter module includes a spirally wound membrane filter, which can be a reverse osmosis filter or other ultrafiltration device.

The gap volume is preferably occupied by a relevant fluid impermeable filler material, which in most embodiments means a water impermeable. This impermeable filler can be affixed to both the outer wall of the filter module and the inner wall of the housing. In some embodiments of the inventive concept, at least about 25% of the gap volume is occupied with a water impermeable filler. In other embodiments of the inventive concept, at least about 50% of the gap volume is occupied with water impermeable filler. In still other embodiments of the inventive concept at least about 90% of the gap volume is occupied with impermeable filler. In yet other embodiments of the inventive concept essentially all of the gap volume is occupied with impermeable filler. The impermeable filler can be or include a polymer, for example an epoxy polymer.

As used herein, the term “fluid impervious” with respect to a fluid and a filler means that no detectable amount of the fluid passes through a 5 mm thick amount of the filler at 50 psi during a period of 100 hours.

Various objects, features, aspects and advantages of the inventive subject matter will become more apparent from the following detailed description of preferred embodiments, along with the accompanying drawing figures in which like numerals represent like components. The embodiments set forth in the drawings are illustrative in nature and are not intended to be limiting of the invention defined by the claims. Moreover, individual features of the drawings and the invention will be more fully apparent and understood in view of the detailed description.

### BRIEF DESCRIPTION OF THE DRAWINGS

FIG. 1 is a diagrammatic representation of a cross section of a prior art reverse osmosis module.

FIG. 2 is a diagrammatic representation of a cross section of an example of a reverse osmosis module of the inventive concept.

FIGS. 3A-3C depict cutaway views of examples of reverse osmosis modules of the inventive concept. FIGS. 3A, 3B, and 3C show reverse osmosis modules with approximately 25%, approximately 50% and approximately 90% of the gap volume filled, respectively.

### DETAILED DESCRIPTION

The devices and methods disclosed herein are directed to treatment or processing of fluids. Such fluids can include gases, liquids, gels, colloids, and/or particulate solids in fluid suspension. Disclosed devices and methods can be applied to a variety of processes, including but not limited to reverse osmosis, desalination, fluid sterilization, diafiltration, solvent removal, solvent exchange, and/or contact exchange.

The inventive subject matter provides apparatus, systems and methods in which one can efficiently perform pressurized filtration of fluids. Such filtration can be performed using a filtration device that includes a filter assembly with a semipermeable membrane that permits selective transport of fluid components across the membrane under a pressure gradient, and a housing that encloses such a filter assembly. As noted above, the rate of transport across such membrane filters is a function of factors such as the available membrane surface area and the magnitude of the pressure differential across the membrane. Use of high pressures during such operations can increase the filtration rate, however this can lead to failure of the housing or one or more seals associated with the housing, which in turn can result in an undesirable loss of fluid and a drop in fluid pressure. In some embodiments of the inventive concept at least a portion of the open volume that remains within the housing when the filter assembly is present is occupied by a fluid impermeable filler material, which can (among other purposes) serve to provide a robust seal that effectively prevents such housing failures, prevent distortion of the semipermeable membrane under high pressure, and reduce or eliminate accumulation of contaminating material in the gap volume between the filter assembly and the housing.

One should appreciate that the disclosed devices and methods provide many advantageous technical effects, including easily implemented and extremely robust sealing of the pressurized housing of the filtration device. Surprisingly, while filler material can prevent access to a portion of the semipermeable membrane the resulting ability to utilize higher pressures during ultrafiltration provides greatly increased filtration rates. This in turn permits the use of smaller and less costly ultrafiltration installations. Occupation of the space between the filter assembly and the wall of the housing also serves to prevent the undesirable retention of particulates and contaminants (particularly microbial contaminants) within the filtration device. In addition, occupation of the volume between the filter assembly and the housing can serve to reduce or prevent “telescoping” or undesirable distortion of the filter assembly at large pressure differentials.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

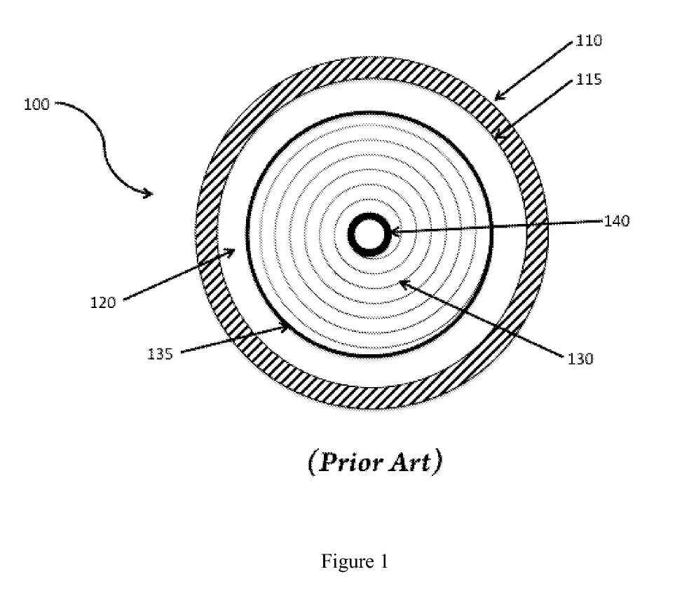

A cross section of a prior art filtration device 100 is shown in FIG. 1. A pressure housing (or housing) 110, which is generally cylindrical, encloses a filter assembly that includes a spirally wound semipermeable membrane 130 and a central permeate line 140. Typical housings can have a cap at one or both ends, which permits access to the interior of the housing to facilitate assembly of the filtration device 100, and such caps can include gaskets, O rings, or similar devices to provide a pressure seal for the housing. Such seals are, however, prone to failure at high pressures. Material that passes through the membrane 130 of the filter assembly is collected and transported out of the filtration device through the permeate line 140. Within the filtration device 100 a gap volume (or gap) 120 is defined by an inner housing wall 115 and the outer filter wall 135. This gap volume 120 is generally filled with feed stream fluid that has bypassed the filter assembly. Without active removal, which can require disassembly of the filtration device 100, particulates and other contaminants from the untreated feed fluid can accumulate within the gap volume 120. This can lead to microbial growth and contamination of the filtration device 100. In addition the presence of this gap can permit the spiral membrane 130 to distort or telescope under pressure, which can adversely and irreversibly impact the performance of the filtration device.

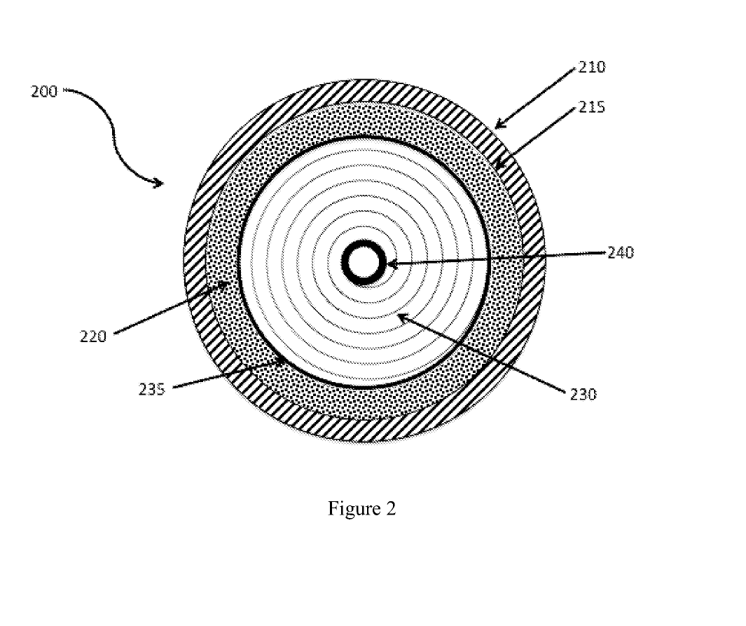

FIG. 2 illustrates a cross section of a device that incorporates an embodiment of the inventive concept. A pressure housing (or housing) 210 encloses a filter assembly that includes a spirally wound semipermeable membrane 230 and a central permeate line 240. Although shown as having an essentially circular cross section, it should be appreciated that the housing can be of any suitable shape, including (but not limited to) shapes having an oval, square, polygonal, or asymmetric cross section and/or having a cross section that varies along an axis of the housing 210. A housing 210 of the inventive concept can be constructed from any material with suitable mechanical strength and chemical reactivity, including (but not limited to) polysulfone, polyether sulfone, polypropylene, ABS resin, AS resin, polystyrene, polyvinyl chloride, polyvinylidene fluoride, polytetrafluoroethylene, tetrafluoroethylene-perfluoroalykyl vinyl ether copolymer resin, ethylene-tetrafluoroethylene copolymer resin, tetrafluoroethylene-hexafluoropropylene copolymer resin, polycarbonate, polyether ketones, polyphenylene ether, polyphenylene sulfide, fiberglass, carbon fiber, polymers that incorporate silica fine powder and/or carbon fine powder, ceramic, glass, stainless steel, magnesium, titanium, aluminum, and/or aluminum alloy. The wall thickness of the housing 210 can be selected to provide sufficient pressure resistance to safely sustain filter operation. For example, a filtration device 200 of the inventive concept can employ a housing 210 made from stainless steel with a wall thickness of about 0.1 inches to about 1 inch. In some embodiments of the inventive concept the filtration device 200 includes a housing 210 made from stainless steel with a wall thickness of about 0.25 inches.

The inner wall 215 of the housing 210 and the outer wall 235 of the filter assembly define a gap volume, at least a portion of which is occupied by a filler material (filler) 220. In some embodiments of the inventive concept the filler is bonded or affixed to both the outer filter wall 235 and the inner housing wall 215. The filler 220 can be an impermeable filler, i.e. a filler that is not permeable to the fluid or fluids that are processed within the filtration device 200. Towards that end, the filler can be nonporous. As such, fluid from a feed stream that bypasses the filter assembly cannot accumulate in the space that is occupied by the filler 220. As a result, space within the filter device that is occupied by the filler is not subject to deposition of contaminants from the untreated feed fluid and is highly resistant to microbial contamination and growth. In addition, portions of the filter assembly that are in contact with the filler have increased resistance to distortion upon application of pressure. Examples of suitable fillers include, but are not limited to, epoxy resin, urethane resin, silicone resin, and copolymers. Such fillers can be introduced to the filtration device in an uncured state during assembly and subsequently cured. In some embodiments of the inventive concept the filler 220 can include one or more antimicrobial compounds. Such filler 220 can occupy part, nearly all, or essentially all of the volume between the inner housing wall 215 and the outer filter wall 235. In some embodiments of the inventive concept the filler 220 occupies at least about 25% of the volume of the gap defined by the inner housing wall 215 and the outer filter wall 235. In other embodiments of the inventive concept the filler 220 occupies at least about 50% of the volume of the gap defined by the inner housing wall 215 and the outer filter wall 235. In still other embodiments of the inventive concept the filler 220 occupies at least about 90% of the volume of the gap defined by the inner housing wall 215 and the outer filter wall 235. In some embodiments of the inventive concept essentially all of the volume of the gap defined by the inner housing wall 215 and the outer filter wall 235 is occupied by filler 220.

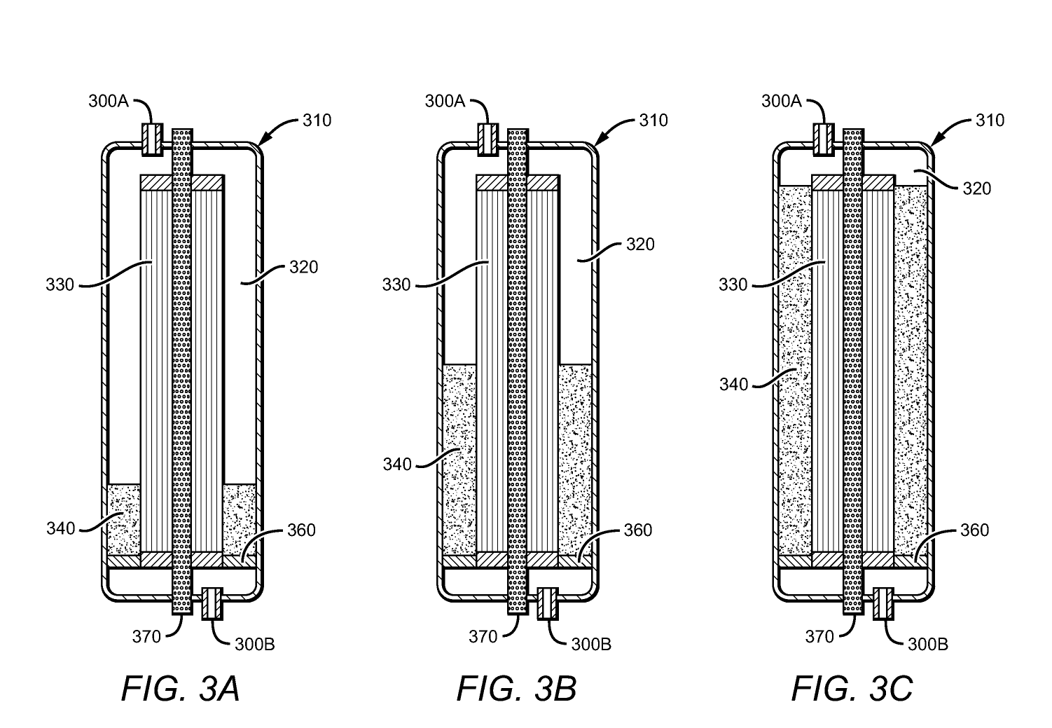

FIGS. 3A-3C depict cutaway views of examples of the inventive concept that embody different volumes of filler material. FIG. 3A, for example, shows a filtration device with a housing 310 that encloses a filter assembly 330. A feed line 300A provides a fluid feed stream to the filter assembly 330. A permeate line 370 and a waste stream line 300B pass filtered fluid and waste fluid, respectively, away from the filtration device. The space between the housing 310 and the filter assembly 330 is either occupied by filler 340 or is an open space 320. This filler is preferably bonded to both the filter assembly 330 and the housing 310. That seal 360 is only used to prevent the flow of filler 340 from filling the entire open space near the bottom of the membrane during the filling operation. In FIG. 3A approximately 25% of the available volume is occupied by filler. FIG. 3B depicts another embodiment of the inventive concept, in which about 50% of the available volume within the filtration device is occupied by filler. FIG. 3C depicts still another embodiment of the inventive concept, in which about 90% or more of the available volume is occupied by filler. Embodiments in which essentially all space within the housing that is not occupied by a filter module and attendant fluid connections is occupied by filler are also contemplated.

Although all realistic positionings of the filtration devices are contemplated, it is currently preferred to rotate the filtration devices 180° from that shown in the figures so that any unfilled space 320 can drain after each operation of the membrane.

The inventor contemplates that filtration devices in which a portion or essentially all of the available volume within the housing that is not occupied by a filter module and attendant fluid connections is occupied by filler have improved resistance to particulate and microbial contamination, as most or all of the accessible surfaces are exposed to fluid flow. It is further contemplated that filtration devices of the inventive concept are resistant to undesirable “telescoping” or distortion of components of the filter assembly when under pressure, which can damage the filtration device.

Filler can be introduced into the filtration device during assembly of the components. For example, a measured volume of an uncured filler can be introduced to a partially assembled filtration device, in which a filter assembly has been placed within a partially assembled housing and necessary feed and permeate connections established. Alternatively, a measured volume of uncured filler can be introduced to a partially assembled housing prior to introduction of the filter assembly or a portion thereof. Following introduction of the uncured filler, which can be in a fluid state, assembly of the housing can be continued by, among other actions, fitting of a gasket or O ring and/or attachment or tightening of a cap. The filtration device can then be reoriented to direct the uncured filler towards the capped portion of the housing for curing. Alternatively, the housing can be fitted with a hole or port through which uncured filler can be introduced following assembly of the filtration device. During addition of the uncured filler, reorientation of the filtration device, and/or curing of the filler the longitudinal axis of the filtration device can be placed at a defined angle from vertical. In some embodiments of the inventive concept the defined angle can be between about 30° and 60° from vertical. In other embodiments of the inventive concept the defined angle can be about 45° from vertical.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps can be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A filtration device comprising:
a housing comprising an inner housing wall;
a filter assembly comprising an outer filter wall; and
wherein the housing is configured to enclose the filter assembly such that the inner housing wall and the outer filter wall define a gap volume, and wherein at least about 25% of the gap volume is occupied by a filler.

2. The filtration device of claim 1, wherein the filter assembly comprises a spirally wound membrane filter.

3. The filtration device of claim 1 wherein the filter assembly comprises a nanofiltration filter.

4. The filtration device of claim 1, wherein the filter assembly comprises a reverse osmosis filter.

5. The filtration device of claim 1 wherein at least about 50% of the gap volume is occupied by the filler.

6. The filtration device of claim 1, wherein at least about 90% of the gap volume is occupied by the filler.

7. The filtration device of claim 1, wherein essentially all of the gap volume is occupied by the filler.

8. The filtration device of claim 1, wherein the filler is fluid impermeable to water.

9. The filtration device of claim 1, wherein the filler is nonporous.

10. The filtration device of claim 1 wherein the filler is affixed to the inner housing wall and affixed to the outer filter wall.

11. The filtration device of claim 9 wherein the filler comprises a polymer.

12. The filtration device of claim 9 wherein the filler comprises an epoxy resin.
